(19) United States
(12) Patent Application Publication
(10) Pub. No.: US 2019/0160338 A1
(43) Pub. Date: May 30, 2019

(54) TRAINING ASSISTANCE DEVICE AND NON-TRANSITORY COMPUTER-READABLE STORAGE MEDIUM

(71) Applicant: SEIKO EPSON CORPORATION, Tokyo (JP)

(72) Inventors: Yuya MARUYAMA, Fuefuki-shi (JP); Hideki TANAKA, Chino-shi (JP)

(73) Assignee: SEIKO EPSON CORPORATION, Tokyo (JP)

(21) Appl. No.: 16/202,296

(22) Filed: Nov. 28, 2018

(30) Foreign Application Priority Data
Nov. 29, 2017 (JP) 2017-228726

(51) Int. Cl. A63B 24/00; A63B 23/16

(52) U.S. Cl. CPC A63B 24/0075; G09B 19/003; A63B 24/0062; A63B 23/16

(57) ABSTRACT

A training assistance device is executed by a CPU and encourages a training recipient to do training. The device includes: a display unit; and a control unit which encourages the training recipient to do training. The control unit outputs a plurality of images represents levels of achievement to the display unit, thus prompts the training recipient to select a level of achievement, and sets training corresponding to the selection.

### BACKGROUND

### 1. Technical Field

The present disclosure relates to a training assistance device and a non-transitory computer-readable storage medium.

### 2. Related Art

According to the related art, a rehabilitation support system which shows a video of a model rehabilitation motion for hand or foot on a head-mounted display device and thus encourages a patient to do rehabilitation is known, for example, as disclosed in JP-A-2015-228957. This can provide rehabilitation in which the patient can easily recognize a target motion. The patient can efficiently carry out rehabilitation.

It is known that a patient can efficiently recover by training that fits the patient's level of achievement. For example, it is known that when a patient with unilateral paralysis as an after-effect of cerebral apoplexy receives training, appropriate rehabilitation varies according to the patient's level of achievement. It has been found that a patient with a low level of achievement on the unilaterally paralyzed side of the body can quickly improve by carrying out a bilateral movement or by moving the joints of the body part to be trained in the same form. It has also been found that a patient with a high level of achievement on the unilaterally paralyzed side of the body can quickly improve by carrying out a unilateral movement on the paralyzed side or by moving the joints of the body part to be trained in different forms. The rehabilitation support system disclosed in JP-A-2015-228957 does not encourage the training recipient to do training that fits the level of achievement. Therefore, with this system, it is difficult to provide training with high achievement efficiency. Thus, a training assistance device that enables a training recipient to select training that fits the level of achievement and to carry out training with high achievement efficiency is demanded.

### SUMMARY

The disclosure can be implemented as the following configurations or application examples.

### Application Example 1

A training assistance device according to this application example includes: a display unit; and a control unit which outputs a plurality of images to the display unit, each of the plurality of images represents a level of achievement. The control unit sets a training that includes a training content corresponding to one level of achievement selected by a selection of one image from the plurality of images.

### Application Example 2

A non-transitory computer-readable storage medium storing a program according to this application example is a program used for a training assistance device having a CPU and a display unit. The program includes: a function of presenting a plurality of images on the display unit, each of the plurality of images represents a level of achievement; a function of prompting a selection of one image from the plurality of images; a function of setting a training content according to the selection; and a function of displaying a training image of the training content on the display unit.

### BRIEF DESCRIPTION OF THE DRAWINGS

The disclosure will be described with reference to the accompanying drawings, wherein like numbers reference like elements.

FIG. 1 is a schematic view of the configuration of a training assistance device.

FIG. 2 is a block diagram of the configuration of the training assistance device.

FIG. 3 is a flowchart of training processing for rehabilitation by the training assistance device.

FIG. 4 is a flowchart of display setting processing.

FIG. 5 is a flowchart of training content setting processing.

FIG. 6 is a schematic view of an input screen.

FIG. 7 is a schematic view for explaining how it looks at the time of a bilateral collaborative movement.

FIG. 8 is a schematic view for explaining how it looks at the time of a unilateral collaborative movement.

FIG. 9 is a schematic view for explaining how it looks at the time of a unilateral separate movement.

### DESCRIPTION OF EXEMPLARY EMBODIMENTS

Hereinafter, an embodiment will be described with reference to the drawings. The drawings below illustrate each component to a scale different from the actual one so that each member is in a recognizable size.

### Embodiment

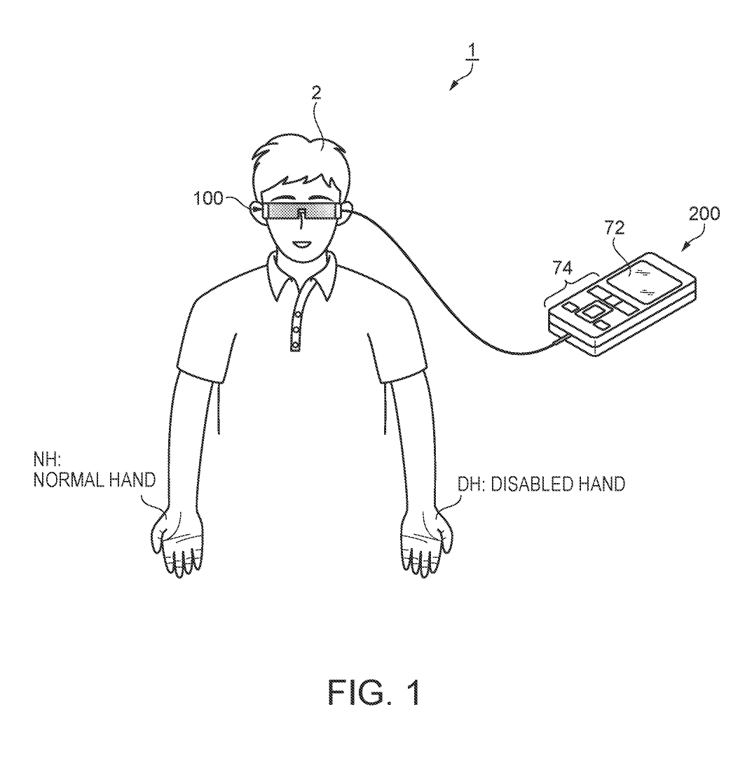

FIG. 1 is a schematic view of the configuration of a training assistance device. A training assistance device 1 includes a display unit 100 and a control unit 200. The training assistance device 1 is a device which encourages a training recipient 2 to do the training and thus assists the training recipient 2 with the training. The training using the training assistance device 1 is for the recovery of functions of a hand as a disabled body part. The disability may be, for example, a paralysis due to cerebral apoplexy. The training assistance device 1 is a device which assists the rehabilitation of a unilaterally paralyzed training recipient 2 having a disabled hand DH and a normal hand NH. In the description below, the term rehabilitation may be abbreviated to “rehab”.

First, a schematic configuration of the display unit 100 and the control unit 200 included in the training assistance device 1 is described. The control unit 200 outputs a plurality of images represents levels of achievement, to the display unit 100, and thus prompts the training recipient 2 to select a level of achievement. That is, the levels of achievement are selectable. Next, the control unit 200 sets training corresponding to the selection, as the training content. The control unit 200 then outputs a training video to the display unit 100 and thus encourages the training recipient 2 to do the training. The level of achievement represents the rate at which the training recipient 2 can do the same movement as the training content. The training video shows a dynamic image which the training recipient 2 refers to in the training.

The configuration of the display unit 100 is not particularly limited. However, in this embodiment, for example, a head-mounted display device (HMD) is employed. The control unit 200 includes a HMD controller. The control unit 200 also includes a touchpad 72 and an operation button unit 74.

The display unit 100 can allow the training recipient 2 to view a virtual image. The display unit 100 is an optical transmission type (see-through type) through which the training recipient 2 can directly view the real space. The display unit 100 can present a training content to the training recipient 2. The touchpad 72 detects a contact operation on an operation surface of the touchpad 72 and outputs a signal corresponding to the detected content. As the touchpad 72, electrostatic, pressure detection type, optical, and various other touchpads can be employed. The operation button unit 74 has various operation buttons, detects an operation on each operation button, and outputs a signal corresponding to the detected content. The touchpad 72 and the operation button unit 74 are operated by a user. The user includes not only the training recipient 2 but also an attendant such as a doctor or physiotherapist.

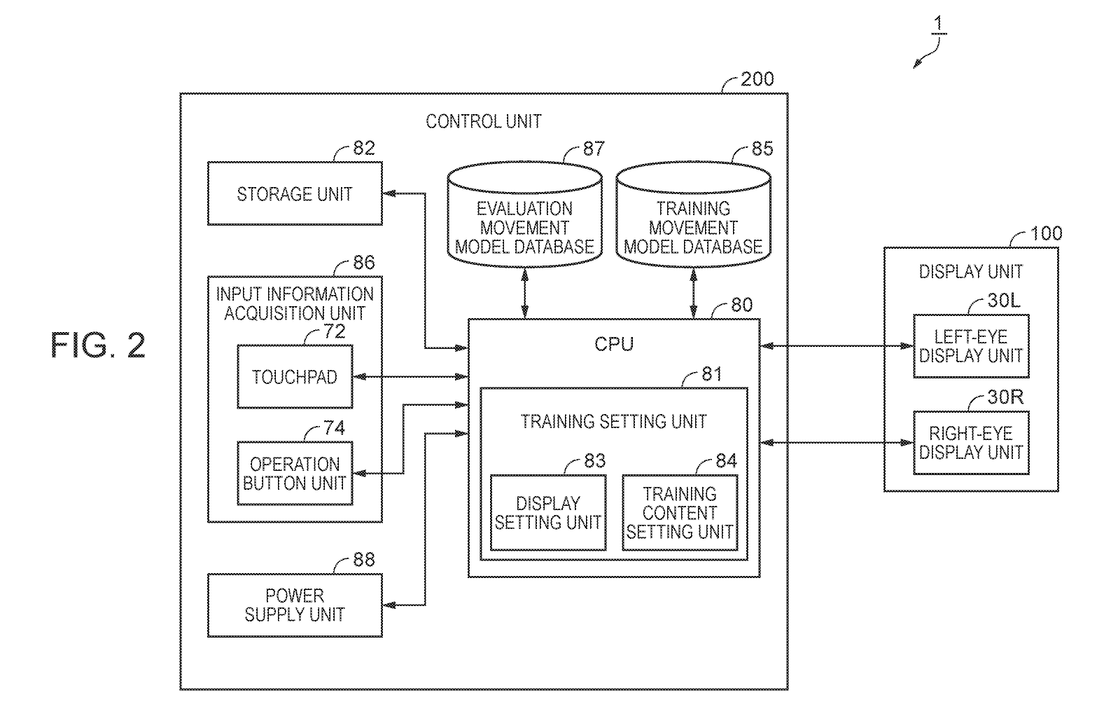

FIG. 2 is a block diagram of the functional configuration of the training assistance device. As shown in FIG. 2, the training assistance device 1 has the display unit 100 and the control unit 200. The display unit 100 has a left-eye display unit 30L and a right-eye display unit 30R, which are connected to a CPU 80 (central processing unit) of the control unit 200 via a wiring.

The right-eye display unit 30R forms symmetry with that of the left-eye display unit 30L and displays an image similar to the image displayed by the left-eye display unit 30L. Consequently, the training recipient 2 can recognize the images by wearing the display unit 100 on the head. The training recipient 2 simultaneously sees the left-eye display unit 30L and the right-eye display unit 30R and thus can see a three-dimensional image. The training recipient 2 can also see the real space while wearing the display unit 100 on the head, since the display unit 100 transmits at least a part of light from the real space.

The control unit 200 has a CPU 80, a storage unit 82, a training movement model database 85, an evaluation movement model database 87, an input information acquisition unit 86, and a power supply unit 88. These components are connected to each other via a wiring such as a bus.

In the storage unit 82, a computer program as a program is stored. The CPU 80 reads out and executes the computer program stored in the storage unit 82 and thus implements various functions. The computer program is a program used in the training assistance device 1 having the CPU 80 and the display unit 100. The functions implemented by the CPU 80 based on the computer program include a training setting unit 81. The training setting unit 81 sets a training content, based on an input from the input information acquisition unit 86. Specifically, the computer program has the function of presenting a plurality of images represents levels of achievement on the display unit 100. The computer program also has the function of prompting the user to select a level of achievement. The computer program also has the function of setting a training content according to the input of the level of achievement of the training recipient 2.

The CPU 80 implements the function of executing processing corresponding to the result of detection if a detected content of an operation is inputted from the input information acquisition unit 86, the function of reading and writing data to and from the storage unit 82, and the function of controlling the supply of electric power to each component from the power supply unit 88.

The CPU 80 also reads out and executes the program stored in the storage unit 82 and thus implements the function of executing training processing for the recovery of functions of a disabled body part of the training recipient 2. That is, the computer program has the function of displaying a training image of a training content on the display unit 100.

The training setting unit 81 includes a display setting unit 83 and a training content setting unit 84. The display setting unit 83 and the training content setting unit 84 set a display content and a training content, based on an input from the input information acquisition unit 86. According to the display content and training content thus set, the CPU 80 prepares a movement video for training.

The storage unit 82 is made up of a ROM (read only memory), RAM (random access memory), DRAM (dynamic random access memory), HDD (hard disk drive) or the like. Various computer programs including an OS (operating system) are stored in the storage unit 82. In this embodiment, one of the stored computer programs is a program for rehab.

The training movement model database 85 and the evaluation movement model database 87 are databases in which movement models are accumulated. A movement model is dynamic image data of a target movement for training as a model. A movement model may be an aggregate of data of several still images instead of dynamic image data. Also, a movement model may be data made up of a set of feature point positions of the hand and can be replaced by any data that can construct a dynamic image. A movement model may also include a parameter such as the number of times and speed of the movement. When the training recipient 2 carries out training, the CPU 80 reads out dynamic data from the training movement model database 85 and outputs a dynamic image represents a training content to the display unit 100. The display unit 100 displays a dynamic image of a movement model. When evaluating the level of achievement of the training recipient 2, the display unit 100 displays an input screen for evaluation. The CPU 80 reads out dynamic image data from the evaluation movement model database 87 and outputs a dynamic image of a movement model on the input screen. The display unit 100 displays the dynamic image of the movement model.

The input information acquisition unit 86 includes touchpad 72 and the operation button unit 74. When the user operates the touchpad 72 and the operation button unit 74, the input information acquisition unit 86 outputs a signal corresponding to the operation content on the touchpad 72 and the operation button unit 74 to the CPU 80.

The power supply unit 88 supplies electric power to each component that is provided in the display unit 100 and the control unit 200 and that needs electric power. The power supply unit 88 may be a battery. Alternatively, electric power may be inputted from the grid.

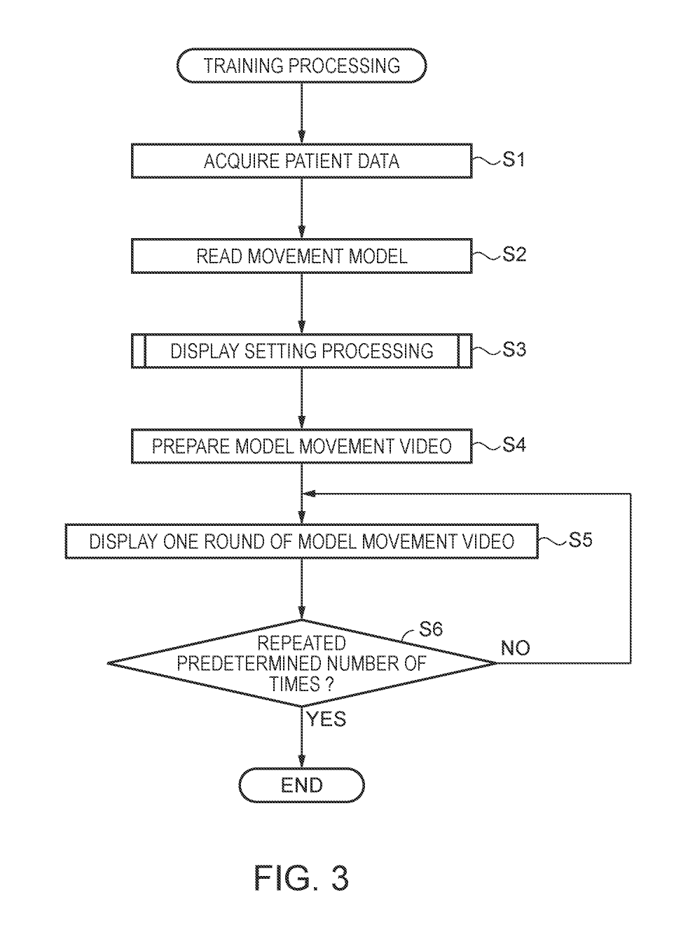

FIG. 3 is a flowchart of training processing for rehabilitation by the training assistance device. The training processing shown in FIG. 3 is executed by the CPU 80. The training processing starts when the touchpad 72 or the operation button unit 74 of the input information acquisition unit 86 accepts a predetermined operation.

As the training processing starts, in step S1, the CPU 80 acquires patient data through the input information acquisition unit 86. The patient data is data including information representing a part to be trained and information representing the level of achievement of the training. The information representing a part to be trained is information including, for example, that the part to be trained is a body part such as a hand finger, wrist, elbow, foot finger, ankle, or knee, and that the target part to be trained is on the right side or the left side. The part to be trained is acquired on the input of information by the training recipient 2.

The information representing the level of achievement of the training is acquired in the following manner. First, the control unit 200 outputs a plurality of images represents levels of achievement to the display unit 100. Next, the display unit 100 displays the plurality of images represents the levels of achievement. Next, the training recipient 2 is prompted to select a level of achievement. As the training recipient 2 selects a level of achievement, information representing the level of achievement of the training is acquired. The training content setting unit 84 then sets training corresponding to the selection, as the training content. The plurality of images represents the levels of achievement is prepared by the CPU 80 reading the evaluation movement model database 87. The plurality of images represents the levels of achievement is stored in advance in the evaluation movement model database 87.

In step S2, the CPU 80 reads a movement model from the training movement model database 85, based on the information representing the part to be trained. A plurality of images represents movement models is stored in advance in the training movement model database 85.

In step S3, the CPU 80 carries out display setting processing. In the display setting processing, the body part to be trained on both sides or one side is displayed, based on the patient data inputted to the display setting unit 83. As the body part on both sides or one side, for example, both hands or both feet, or one hand or one foot is shown. The display setting unit 83 then sets a training content. The training content includes, for example, the number of times the movement is to be repeated.

In step S4, the CPU 80 prepares a model movement video. The model movement video is prepared, using the movement model read from the training movement model database 85 and based on the content set by the display setting processing.

In step S5, the CPU 80 outputs one round of the model movement video to the display unit 100. The one round refers to, for example, doing a reciprocal movement once, such as bending and then stretching the fingers. The training recipient 2 carries out the reciprocal movement, viewing the model movement video.

In step S6, the CPU 80 carries out determination processing about whether the number of times the model movement video is displayed has reached a preset number of times of display or not. The number of times the model movement video is displayed is set by the display setting unit 83 in step S3. If the number of times the model movement video is displayed is less than a predetermined number of times, the processing returns to step S5 and the training processing continues. If the number of times the model movement video is displayed has reached the predetermined number of times, the display of the model movement video ends and the training processing ends. The predetermined number of times is the number of times the training recipient 2 continues one round of the training. Instead of the predetermined number of times, an amount of movement may be set in the form of a predetermined time.

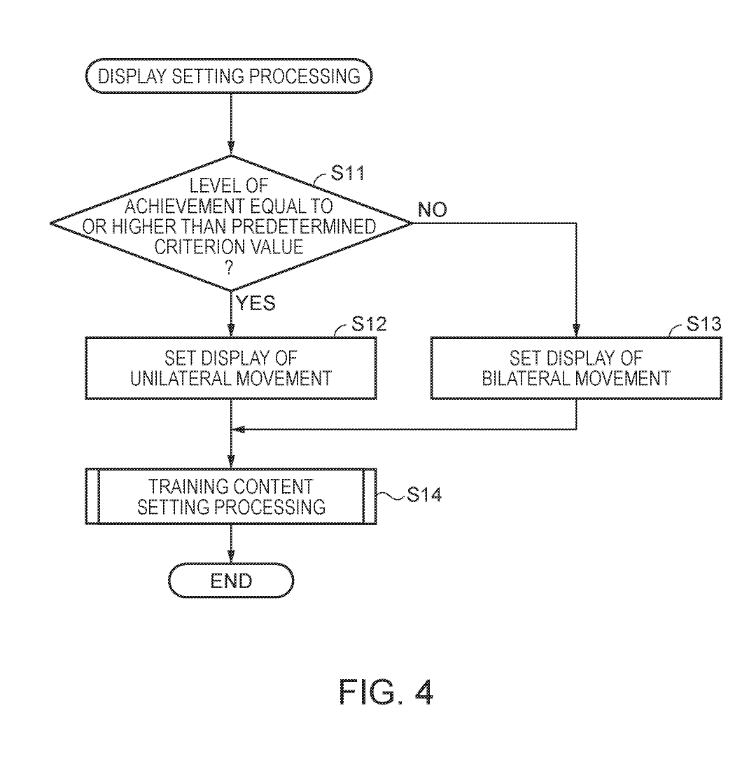

FIG. 4 is a flowchart of the display setting processing of step S3. This display setting processing is executed by the CPU 80 and starts after the movement model is read in step S2.

As the display setting processing of step S3 starts, the CPU 80 in step S11 carries out determination processing about whether the level of achievement is equal to or higher than a predetermined criterion value, or not. If the level of achievement is equal to or higher than the predetermined criterion value, the CPU 80 carries out the processing of step S12. If the level of achievement is lower than the predetermined criterion value, the CPU 80 carries out the processing of step S13. The level of achievement is set, based on the patient data inputted by the training recipient 2 in step S1. As an indicator indicating the level of achievement, for example, the Brunnstrom Stages (BRS) is used for rehab from unilateral paralysis. The BRS includes stages 1 to 6 indicating stages of recovery from unilateral paralysis. A smaller stage number means a higher severity. In step S11, the criterion value is set, based on whether the unilaterally paralyzed body part is able to move or not. A patient in BRS stage 1 can hardly move the unilaterally paralyzed body part. Meanwhile, a patient in BRS stages 2 to 6 can move the unilaterally paralyzed body part. In this embodiment, for example, the predetermined criterion value is BRS 2. BRS 1 is determined as lower than the criterion value. BRS 2 to 6 are determined as equal to or higher than the criterion value.

In step S12, the display setting unit 83 of the CPU 80 sets training on one side of the body with the one side of the body displayed, as the training content, if the level of achievement is equal to or higher than the predetermined criterion value. If the BRS is 2 to 6, one side of the body is displayed on the display unit 100, thus allowing the training recipient 2 to train the one side of the body. For example, it is known that if a patient who has a unilateral paralysis as an after-effect of cerebral apoplexy but can move the paralyzed side of the body carries out a movement on both sides of the body, the movement on the normal side obstructs the physical movement on the paralyzed side. Therefore, by training only the one side of the body, the training recipient 2 can carry out training without the physical movement on the side with a high level of achievement obstructing the physical movement on the side with a low level of achievement. The training recipient 2 can concentrate on the physical movement on the side with a low level of achievement. Thus, training with high achievement efficiency can be provided for the training recipient 2 when the level of achievement is equal to or higher than the predetermined criterion value.

In step S13, the display setting unit 83 of the CPU 80 sets training on both sides of the body with both sides of the body displayed, as the training content, if the level of achievement is lower than the predetermined criterion value. If the BRS is 1, displaying both sides of the body on the display unit 100 enables the training recipient 2 to train both sides of the body. For example, it is known that if a patient who has a unilateral paralysis as an after-effect of cerebral apoplexy and cannot move the paralyzed side carries out a movement on both sides of the body, the movement on the normal side induces a physical movement on the paralyzed side. Therefore, when the level of achievement is lower than the predetermined criterion value, by training both sides of the body, the training recipient 2 can carry out training in which the physical movement on the side with a high level of achievement induces the physical movement on the side with a low level of achievement. Thus, training with high achievement efficiency can be provided.

In step S14, the training content setting unit 84 of the CPU 80 carries out training content setting processing. In the training content setting processing, one of bilateral collaborative movement, unilateral collaborative movement, and unilateral separate movement as separate movement, is set as the training content, based on the inputted patient data. The collaborative movement refers to a movement in which the joints of the body part to be trained are moved in the same form. For example, the collaborative movement means that the individual hand fingers are in the same flexion state. The unilateral separate movement refers to a movement in which the joints of the body part to be trained are moved in different forms. For example, the unilateral separate movement means that the individual hand fingers are in different flexion states.

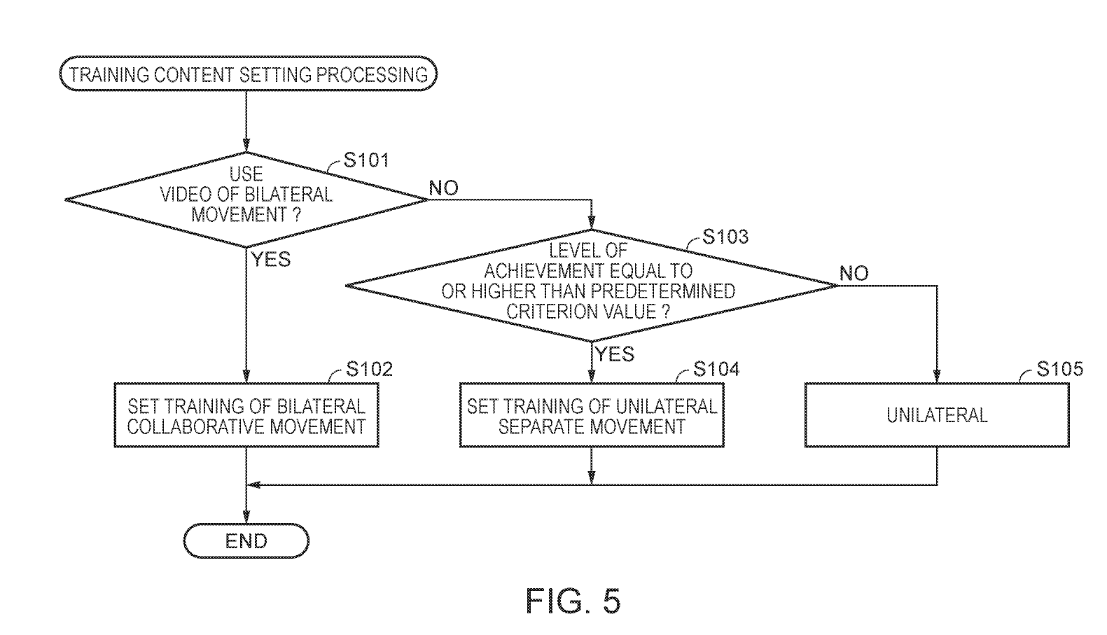

FIG. 5 is a flowchart of the training content setting processing of step S14. The training content setting processing is executed by the training content setting unit 84 of the CPU 80 and starts after the display of bilateral movement or unilateral movement is set in step S12 or S13.

As the training content setting processing starts, the training content setting unit 84 in step S101 carries out determination processing about the use of a video of the bilateral or unilateral movement set by the display setting processing. If it is determined that a video of the bilateral movement is to be used, the training content setting unit 84 carries out the processing of step S102. If it is determined that a video of the bilateral movement is not to be used, the training content setting unit 84 carries out the processing of step S103. If a video of the bilateral movement is not used, it means that a video of the unilateral movement is to be used.

In step S102, when training on both sides of the body is set, the training content setting unit 84 decides to use a video of the bilateral movement and sets a bilateral collaborative movement as the training content. The bilateral collaborative movement refers to, for example, a movement in which the individual fingers of both hands are moved in the same flexion state. If the level of achievement is low, the left and right joints of the body are displayed as moving in the same form, allowing a training recipient with a low level of achievement to easily carry out this movement. Therefore, for the training recipient 2 with a low level of achievement, the collaborative movement is suitable as the training content. Thus, training with high achievement efficiency can be provided for the training recipient 2 when both sides of the body are displayed.

In step S103, the training content setting unit 84 decides not to use a video of the bilateral movement and carries out determination processing about whether the level of achievement is equal to or higher than a predetermined criterion value, or not. If the level of achievement of the training recipient 2 is equal to or higher than the predetermined criterion value, the training content setting unit 84 carries out the processing of step S104. If the level of achievement is lower than the predetermined criterion value, the training content setting unit 84 carries out the processing of step S105. The level of achievement is set, based on the patient data inputted by the training recipient 2 in step S1. For example, for rehabilitation from a unilateral paralysis, a criterion value is set, based on whether the unilaterally paralyzed body part can make a separate movement or not. A patient in BRS stages 1 to 3 cannot carry out a separate movement of the unilaterally paralyzed body part. Meanwhile, a patient in BRS stages 4 to 6 can carry out a separate movement of the unilaterally paralyzed body part. Thus, for example, if the predetermined criterion value is BRS 4, the BRS 1 to 3 are determined as lower than the criterion value and BRS 4 to 6 are determined as equal to or higher than the criterion value.

In step S104, the training content setting unit 84 sets a unilateral separate movement as a separate movement carried out with one side of the body displayed on the display unit 100, as the training content, if the level of achievement of the training recipient 2 is equal to or higher than the predetermined criterion value. The unilateral separate movement is, for example, a movement in which the individual fingers of one hand are moved in different flexion states. Separately moving individual parts of the body stimulates the brain better. If the level of achievement is equal to or higher than the predetermined criterion value and therefore high, the unilateral separate movement with one side of the body displayed is suitable as the training content. Thus, training with high achievement efficiency can be provided for the training recipient whose level of achievement is equal to or higher than the predetermined criterion value, by allowing the training recipient to carry out the separate movement with the display of one side of the body.

In step S105, the training content setting unit 84 sets a unilateral collaborative movement as a collaborative movement carried out with one side of the body displayed on the display unit 100, as the training content, if the level of achievement of the training recipient 2 is lower than the predetermined criterion value. The unilateral collaborative movement is, for example, a movement in which the individual fingers of one hand are moved in the same flexion state. In this case, the training recipient 2 carries out the collaborative movement, paying attention to the image represents the one side of the body. If the level of achievement is lower than the predetermined criterion value and therefore low, the collaborative movement with one side of the body displayed is suitable as the training content. Thus, training with high achievement efficiency can be provided for the training recipient 2 whose level of achievement is lower than the predetermined criterion value, by allowing the training recipient to carryout the collaborative movement with the display of one side of the body.

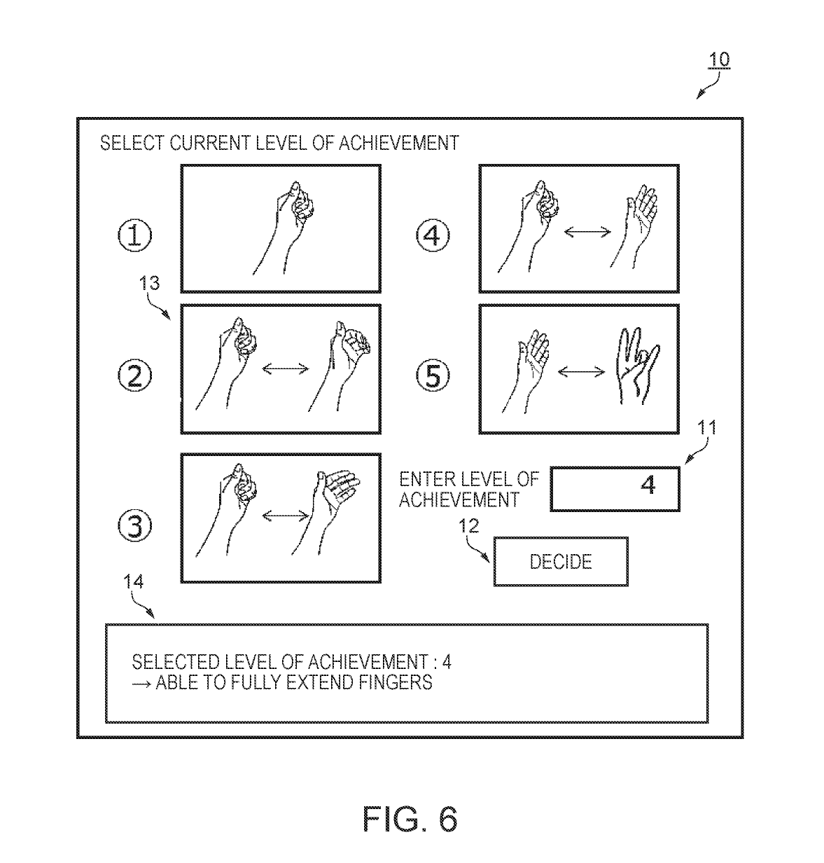

Next, a part of the steps shown in the flowcharts of FIGS. 3 to 5 will be described in detail with reference to FIGS. 6 to 9.

FIG. 6 is a schematic view for explaining an input screen 10. The input screen 10 shown in FIG. 6 is outputted by the training content setting unit 84 to the display unit 100 so as to prompt the training recipient 2 to input the level of achievement in step S1. The input screen 10 includes an input section 11, a setting unit 12, a plurality of dynamic images 13 of respective levels of achievement corresponding to a plurality of images represents levels of achievement displayed to input a level of achievement, and an explanatory text 14 of the level of achievement.

In the input section 11, the training recipient 2 inputs his/her own level of achievement. The training recipient 2 refers to the plurality of dynamic images 13 of the respective levels of achievement and selects and inputs the number of the dynamic image 13 of the level of achievement that seems to be the same as his/her own level of achievement. The training recipient 2 operates the touchpad 72 to input the number. The input content is recognized by the input information acquisition unit 86 and transmitted to the CPU 80.

The setting unit 12 is displayed as “decide” on the input screen 10. The setting unit 12 is a part of the touchpad 72. The training recipient 2 presses the setting unit 12 of the touchpad 72 after inputting the selected level of achievement in the input section 11. This operation sets the level of achievement.

The plurality of dynamic images 13 of the respective levels of achievement is presented as a reference for the training recipient 2 to select the level of achievement. Dynamic images can present levels of achievement more intelligibly to the training recipient 2 than still images. The plurality of dynamic images 13 of the respective levels of achievement shows dynamic images including one of the flexion angle, flexion speed, and flexion timing of the joints of the hand.

For example, the plurality of dynamic images 13 of the respective levels of achievement shows dynamic images expressing the BRS. BRS 6 is the state where the physical movement has recovered to a level equivalent to the normal side. Therefore, the plurality of dynamic images 13 of the respective levels of achievement shows dynamic images expressing BRS 1 to 5.

In the top left part of the illustration, a dynamic image corresponding to BRS 1 is shown. The dynamic image corresponding to BRS 1 is a dynamic image in which the left hand can hardly open or close. In the middle left part of the illustration, a dynamic image corresponding to BRS 2 is shown. In the bottom left part of the illustration, a dynamic image corresponding to BRS 3 is shown. In the top right part of the illustration, a dynamic image corresponding to BRS 4 is shown. The dynamic images corresponding to BRS 2 to 4 are dynamic images in which the left hand makes an opening/closing motion. The angle to which the joints of the opening/closing left hand move increases as the BRS increases. In the middle right part of the illustration, a dynamic image corresponding to BRS 5 is shown. The dynamic image corresponding to BRS 5 is a dynamic image of an opposition movement of the fingers. The opposition movement of the fingers refers to a movement in which the thumb and each of the other fingers are moved to touch each other in order.

In this way, a plurality of dynamic images of respective levels of achievement displayed to input a level of achievement includes dynamic images including one of the flexion angle, flexion speed, and flexion timing of the joints of the hand. The flexion angle, flexion speed, and flexion timing of the joints of the hand are hard to understand from still images and can be more easily understood from the dynamic images displayed. In this way, dynamic images can present levels of achievement more intelligibly to the training recipient than still images. Thus, presenting dynamic images that fit the level of achievement of the training recipient enables the training recipient 2 to easily recognize the levels of achievement.

As the explanatory text 14 of the level of achievement, a sentence explaining the plurality of dynamic images 13 of the respective levels of achievement is displayed. When the training recipient 2 selects a dynamic image 13, the explanation of the selected dynamic image 13 is displayed. The training recipient 2 can easily understand the levels of achievement, referring to the plurality of dynamic images 13 of the respective levels of achievement and the explanatory text 14 of the levels of achievement.

The training recipient 2 selects a level of achievement on the input screen 10 presented by the display unit 100. The training recipient 2 checks the plurality of dynamic images 13 of the respective levels of achievement and selects the dynamic image 13 of the same level of achievement as his/her own. The training recipient 2 then checks the explanatory text 14 of the level of achievement, subsequently inputs the level of achievement in the input section 11, and presses the setting unit 12, thus selecting the level of achievement.

In this way, the training assistance device 1 outputs a plurality of images represents levels of achievement to the input screen 10 and prompts the training recipient 2 to select a level of achievement. That is, the levels of achievement are selectable.

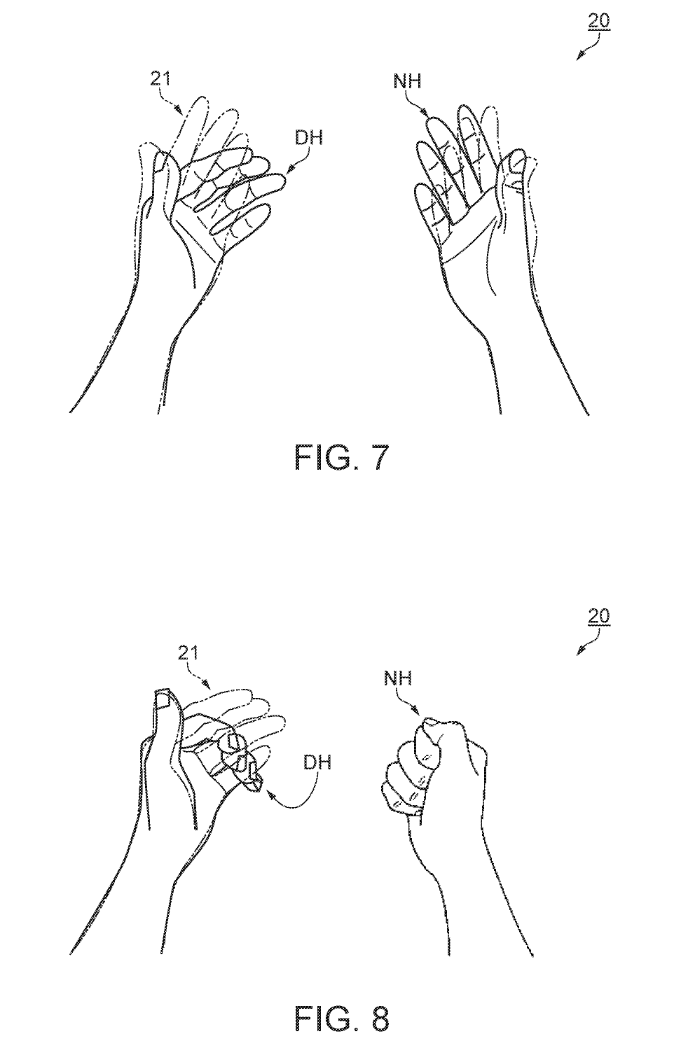

FIGS. 7 to 9 are schematic views for explaining an image which is displayed on the display unit 100 in step S5 of the training processing and which the training recipient 2 refers to in training. The image displayed on the display unit 100 which the training recipient 2 refers to in training is defined as a training display 20. The training display 20 includes the disabled hand DH of the training recipient 2, the normal hand NH of the training recipient 2, and a body part 21 of a training video. As the body part 21 of the training video, the video of the physical movement set in step S3 is displayed.

FIG. 7 is a schematic view for explaining how it looks at the time of a bilateral collaborative movement. The body part 21 of the training video is a video of a bilateral collaborative movement of both hands, as a view represents both sides of the body. The training video is a video of a movement in which the joints of the individual fingers of both hands as the body part 21 are in the same flexion state. This video is, for example, a video presented when the training recipient 2 selects BRS 1 as the level of achievement. The training video shows a movement in which the fingers of both hands are simultaneously bent and stretched. The training recipient 2 carries out the training of bending and stretching the fingers of both hands with the training video.

FIG. 8 is a schematic view for explaining how it looks at the time of a unilateral collaborative movement. The training video is a video of a unilateral movement represents one hand of the body part 21. In the training video, the body part 21 makes a movement in which the joints of the individual fingers of the one hand move in the same flexion state. In other words, the closed hand and the opened hand are repeated. The video of this movement is, for example, a training video presented when the training recipient 2 selects BRS 2 or 3 as the level of achievement. The training video shows a movement in which the fingers of the one hand are bent and stretched. The training recipient 2 carries out the training of bending and stretching the fingers of the one hand with the training video. The fingers of the one hand to be trained are of the disabled hand DH.

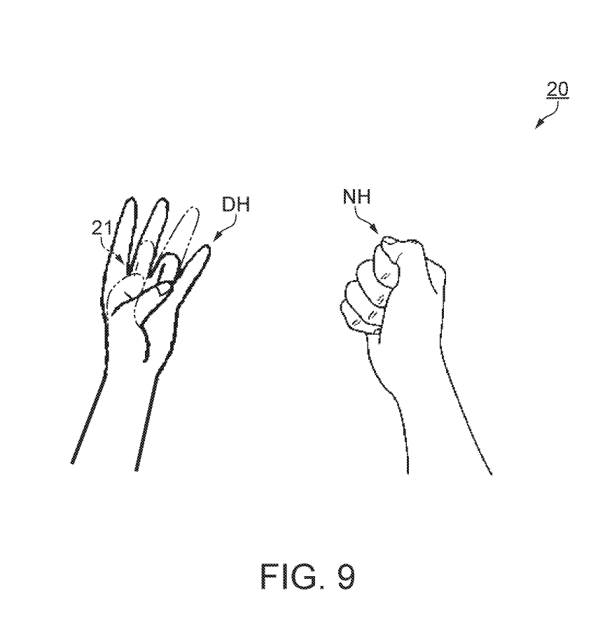

FIG. 9 is a schematic view for explaining how it looks at the time of a unilateral separate movement. The training video is a video of a unilateral movement represents one hand of the body part 21. In the training video, the body part 21 makes a movement in which the joints of the individual fingers of the one hand are indifferent flexion states from each other. For example, this video is a training video presented when the training recipient 2 selects BRS 4 to 6 as the level of achievement. The training video shows an opposition movement of the fingers of the one hand. The opposition movement of the fingers refers to a movement in which the thumb and each of the other fingers are moved to touch each other in order. The training recipient 2 carries out the opposition movement of the fingers of the one hand with the training video. The one hand to be trained is the disabled hand DH.

As described above, the training assistance device 1 has the following effects.

(1) In the embodiment, the control unit 200 outputs a plurality of images represents levels of achievement to the display unit 100. The display unit 100 displays the plurality of images. The training recipient 2 is then prompted to select a level of achievement. The levels of achievement are selectable. Thus, the control unit 200 can set a training content corresponding to the level of achievement. The set training content is presented to the training recipient 2, thus encouraging the training recipient 2 to do the training. The training recipient 2 can quickly achieve the training content by doing the training that fits the level of achievement of the training recipient 2. Thus, the training assistance device 1 that realizes high achievement efficiency by encouraging the training recipient 2 to do training that fits the level of achievement can be provided.

(2) In the embodiment, the control unit 200 sets to display both sides of the body if the level of achievement is lower than a predetermined criterion value. The both sides of the body refer to both hands or both feet. If the level of achievement is lower than the predetermined criterion value, both sides of the body are displayed to encourage the training recipient 2 to train both sides of the body. It has been found that training both sides of the body induces a physical movement on the side with a low level of achievement, of the two sides of the body, and therefore leads to quick improvement. Thus, when the level of achievement is lower than the predetermined criterion value, training with high achievement efficiency can be provided for the training recipient 2.

(3) In the embodiment, the control unit 200 sets to display one side of the body as the training content if the level of achievement is equal to or higher than a predetermined criterion value. If the level of achievement is equal to or higher than the predetermined criterion value, one side of the body is displayed, thus encouraging the training recipient 2 to train one side of the body. By training only one side of the body, the training recipient can do the training without the physical movement on the side with a high level of achievement obstructing the physical movement on the side with a low level of achievement. Thus, when the level of achievement is equal to or higher than the predetermined criterion value, training with high achievement efficiency can be provided for the training recipient 2.

(4) The control unit 200 sets a collaborative movement as the training content when both sides of the body are displayed. The collaborative movement refers to a movement in which the joints of the body part to be trained are moved in the same form. When both sides of the body are displayed, the level of achievement is low and therefore the collaborative movement for a low level of achievement is suitable as the training content. Thus, training with high achievement efficiency can be provided for the training recipient 2 when both sides of the body are displayed.

(5) In the embodiment, the control unit 200 sets a collaborative movement with one side of the body displayed, as the training content, if the level of achievement is lower than a predetermined criterion value. If the level of achievement is lower than the predetermined criterion value, the collaborative movement with one side of the body displayed is suitable as the training content. The training recipient carries out the collaborative movement with the display of one side of the body. Thus, training with high achievement efficiency can be provided for the training recipient 2 when the level of achievement is lower than predetermined criterion value.

(6) In the embodiment, the control unit 200 sets a separate movement with one side of the body displayed, as the training content, if the level of achievement is equal to or higher than a predetermined criterion value. If the level of achievement is equal to or higher than the predetermined criterion value, the separate movement carried out with one side of the body displayed is suitable as the training content. The training recipient carries out the separate movement with the display of one side of the body. Thus, training with high achievement efficiency can be provided for the training recipient 2 when the level of achievement is equal to or higher than the predetermined criterion value.

(7) In the embodiment, the display unit 100 includes the plurality of dynamic images 13 represents levels of achievement and the explanation text 14 of the levels of achievement to be displayed to input a level of achievement. The training recipient 2 can easily understand each level of achievement, referring to the dynamic image and the explanation text 14 for each level of achievement.

(8) In the embodiment, the display unit 100 shows dynamic images including one of the flexion angle, flexion speed, and flexion timing of the joints of a hand, as the plurality of dynamic images 13 for each level of achievement displayed to input a level of achievement. The dynamic images can present the levels of achievement more intelligibly to the training recipient 2 than still images. Thus, since the dynamic image that fits the level of achievement of the training recipient 2 is presented, the training recipient 2 can easily recognize the level of achievement.

(9) In the embodiment, the program outputs a plurality of images represents levels of achievement to the display unit 100. The display unit 100 displays the plurality of images. The program then prompts the training recipient 2 to select a level of achievement. Thus, the program can set a training content according to the level of achievement. The program displays a dynamic image of the set training content on the display unit 100, thus encouraging the training recipient to do the training. The training recipient 2 can quickly achieve the training content by doing the training that fits the level of achievement of the training recipient 2. Thus, the program can provide training with high achievement efficiency by encouraging the training recipient 2 to do the training that fits the level of achievement.

In the embodiment, the CPU 80 executes a program, thus implementing each functional component of the control unit 20 by the working of software. However, each functional component of the control unit 200 can also be implemented by hardware such as an integrated circuit or can be implemented by collaboration of software and hardware.

The disclosure is not limited to the foregoing embodiment. Various modifications, improvements and the like can be added to the embodiment. Some modifications are described below.

### Modification 1

In the embodiment, the body part to be trained is hand fingers. As a modification of this, the body part to be trained may be the wrist, elbow, foot fingers, ankle, or knee.

### Modification 2

In the embodiment and the modification, the training recipient 2 is a unilaterally paralyzed patient. As a modification of this, the training recipient 2 may be able-bodied and may employ movement training for sports or for playing musical instruments or the like.

### Modification 3

In the embodiment and the modifications, the display unit 100 is a head-mounted display device. As a modification of this, the display unit 100 may be a CRT (cathode ray tube), liquid crystal display, plasma display, organic EL (electro-luminescence) display, projector or the like.

### Modification 4

In the embodiment and the modifications, the criterion value for the level of achievement is the BRS. As a modification of this, the criterion value for the level of achievement may be the FIM (functional independence measure) indicating the recovery process of rehab, or other indicators than the BRS that indicate the level of achievement of the body such as the angle to which the joint moves or the speed at which the joint moves.

### Modification 5

In the embodiment and the modifications, the opposition movement of the fingers is used as the separate movement. As a modification of this, the separate movement may be a movement of bending and stretching the fingers in order, a movement of pinching with the neighboring fingers, a movement of grasping a tool such as a glass or ball, and the like.

### Modification 6

In the embodiment and the modifications, the unilateral separate movement is the movement of the disabled hand DH only. As a modification of this, a movement of the normal hand NH that is not the same movement as the disabled hand DH may be added to the training content. For example, a coordinated action of both hands such as passing a tool from the normal hand NH to the disabled hand DH may be employed.

The entire disclosure of Japanese Patent Application No. 2017-228726, filed Nov. 29, 2017 is expressly incorporated by reference herein.

What is claimed is:

1. A training assistance device comprising:
a display unit; and
a control unit which outputs a plurality of images to the display unit, each of the plurality of images represents a level of achievement,
wherein the control unit sets a training that includes a training content corresponding to one level of achievement selected by a selection of one image from the plurality of images.

2. The training assistance device according to claim 1, wherein
an indicator of one level of achievement is lower than a predetermined criterion value,
the training is to train both sides of the body.

3. The training assistance device according to claim 1, wherein
an indicator of one level of achievement is equal to or higher than a predetermined criterion value,
the training is to train one side of the body.

4. The training assistance device according to claim 2, wherein
the training content is a collaborative movement.

5. The training assistance device according to claim 3, wherein
the training content is a collaborative movement to be carried out with one side of the body displayed on the display unit.

6. The training assistance device according to claim 3, wherein
the training content is a separate movement carried out with one side of the body displayed on the display unit.

7. The training assistance device according to claim 1, wherein
the display unit displays a set of a dynamic image and an explanation text corresponding to one level of achievement.

8. The training assistance device according to claim 1, wherein
the display unit displays a dynamic image including one of flexion angle, flexion speed, and flexion timing of joints of a hand.

9. A non-transitory computer-readable storage medium storing a program used for a training assistance device having a CPU and a display unit, the program comprising:
a function of presenting a plurality of images on the display unit, each of the plurality of images represents a level of achievement;
a function of prompting a selection of one image from the plurality of images;
a function of setting a training content according to the selection; and
a function of displaying a training image of the training content on the display unit.
